(19) United States
(12) Patent Application Publication
(10) Pub. No.: US 2002/0112616 A1
(43) Pub. Date: Aug. 22, 2002

(54) Apparatus and method for producing and filling sausage meat

(76) Inventor: Georg Staudenrausch, Biberbach (DE)

Correspondence Address: MARSHALL, GERSTEIN & BORUN, 6300 SEARS TOWER, 233 SOUTH WACKER, CHICAGO, IL, 60606-6357, US

(21) Appl. No.: 10/056,705

(22) Filed: Jan. 24, 2002

(30) Foreign Application Priority Data
Jan. 26, 2001 (EP) 011 01 817.3

(51) Int. Cl. A23C 3/02

(52) U.S. Cl. 99/483

(57) ABSTRACT

The present invention relates to an apparatus and a method for producing and filling sausage meat, the apparatus comprising a producing station for producing sausage meat and a filling station for filling the sausage meat produced by the producing station. The apparatus and the method are characterized in that, on the basis of the amount of sausage meat needed in the filling process or by the filling station, sausage meat is ejected in the producing process or by the producing station at at least a rate which lies between the rate of a deactivated and a full-load producing process and of a corresponding producing station, respectively.

The present invention relates to an apparatus for producing and filling sausage meat, the apparatus comprising a producing station for producing sausage meat and a filling station for filling the sausage meat produced. The invention further relates to a method for producing sausage meat.

U.S. Pat. No. 4,747,342 discloses a meat emulsifier apparatus in which air contact of the meat material is avoided between the emulsifier and the packaging apparatus. Furthermore, a reservoir is disclosed which is operatively coupled with the emulsifier and the packaging apparatus and stores ejected emulsions. If more meat emulsion is produced than packaged, the reservoir will fill up until it reaches a full-load or upper limit, whereby a water supply, a grinder and an emulsifier are switched off. While the reservoir is being emptied, the pump, the water pump, the grinder and the emulsifier will be reactivated when an empty or low point has been reached.

Said apparatus has the drawback that at times at which the production of the emulsion is stopped, the semifinished product remains in the production machine. The emulsion which has aged due to deactivation is, however, automatically supplied further during the production process and packaged accordingly.

Known are also devices which comprise a large intermediate tank (volume of a few hundred liters) between the sausage-meat producing device and the filling device. Such intermediate tanks result in excessively long dwell times of the sausage meat in the reservoir and are detrimental to the sausage meat quality, for instance, due to oxidation.

It is therefore the object of the present invention to provide an apparatus and a method in which a further processing of aged sausage meat is avoided.

This object is achieved by an apparatus comprising the features of claim 1 and by a method comprising the features of claim 16.

In the apparatus according to the invention, a means is provided for determining the amount of sausage meat needed by the filling station and, further, a control means which on the basis of the determined sausage amount demand controls the sausage meat output of the sausage-meat producing station. The sausage-meat producing station can here eject sausage meat at at least a rate (sausage meat quantity/time unit) which lies between the rates at which the sausage-meat producing station is deactivated or operated under full load, respectively.

Due to the possibility of producing sausage meat at at least one intermediate rate, it is possible to operate the sausage-meat producing station continuously although the sausage meat throughput in the sausage-meat filling station is variable in time. The formation of aged sausage meat can thereby be prevented.

If the amount of sausage meat needed by the filling station is low, the sausage meat production can be slowed down without any impairment in the quality of the sausage meat. However, if the amount of sausage meat needed by the filling station is high, the sausage meat produced can be ejected at a maximum rate and thus with maximum cost efficiency.

The use of large-volume sausage meat reservoirs prior to the sausage-meat filling process can thus be avoided.

An advantageous embodiment of the apparatus according to the invention consists in providing the control means such that the sausage meat output of the sausage-meat producing station is controlled substantially continuously. The term “substantially continuously” refers to the possibilities of inducing the sausage-meat producing station to eject sausage meat at, for instance, several thousands of different rates by means of a digital output signal of the control device or, however, of inducing the station to eject sausage meat continuously by means of an analog control signal. It is thereby possible to operate the sausage-meat producing station at a constant rate for a period of time that is as long as possible, and thus to achieve a maximally homogeneous product quality of the sausage meat produced. Due to the substantially continuous adjustability of the output rate of the sausage meat, said rate can be adapted to the long-term mean of the sausage meat throughput of the filling station.

A further advantageous embodiment of the apparatus according to the invention consists in providing at least one reservoir for sausage meat in the filling station, i.e. after the sausage-meat producing station. With such a reservoir it is possible to compensate short-term changes in the throughput of sausage meat in the filling station without any ensuing change in the output rate of sausage meat from the producing station. The capacity of the reservoir may preferably range from 50 to 100 liters, but may also be above or below said range. If the instantaneous sausage meat throughput of the filling station is zero or very low, the sausage meat ejected by the producing station can be temporarily stored in the reservoir without any ensuing decrease in the sausage meat output of the sausage-meat producing station. However, if—in comparison with the output of the producing station—the throughput of sausage meat in the filling station is very high, the amount of sausage meat in the reservoir will decrease.

A further advantageous embodiment of the invention consists in sensing the sausage meat throughput of the sausage-meat filling station for determining the amount of sausage meat needed. With an extremely high portioning accuracy, it is possible to sense the sausage meat throughput of a filling station with corresponding precision. It is thereby possible to determine the amount of sausage meat taken from the reservoir and to detect, on the basis thereof, the amount of sausage meat needed by the filling station.

A further advantageous embodiment of the invention consists in providing at least one pipe for transporting sausage meat between the sausage-meat producing station and the filling station. With such a pipe, it is possible to transport the sausage meat hygienically and under exclusion of air away from the sausage-meat producing station and to the sausage-meat filling station.

A further advantageous embodiment of the apparatus according to the invention consists in that the sausage-meat producing station comprises a grinder and/or a mixer and/or an evacuator and/or a pump and/or an emulsifier whose sausage meat throughput is controlled by the control means. Thanks to the possibility of controlling the throughput of the various means of the sausage-meat producing station, it is possible to ensure an optimum product quality in accordance with the required sausage meat output of the sausage-meat producing station. Thanks to the possibility of coordinating the various means in the sausage-meat producing station with one another, the throughput of the respective means can be controlled for various ejection rates of the sausage-meat producing station such that a constant product quality ensues for each output rate.

An advantageous embodiment of the invention consists in providing a plurality of filling stations. As a rule, the capacity of a sausage-meat producing station is usually clearly above the capacity of a sausage-meat filling station. It is therefore advantageous to operate the sausage-meat producing station with maximum capacity, if possible, and to provide an appropriate number of sausage-meat filling stations.

Advantageously, at least one reservoir is here provided for each filling station. It is thereby possible to operate each individual filling station independently of the other filling stations and to avoid objectionable interferences between the various filling stations, for instance, by pressures varying in time in the feed lines to the individual filling stations. Furthermore, thanks to the provision of a reservoir for each filling station, it is possible to ensure a constant pressure of the sausage meat at the inlet of each filling station. This is of particular advantage with respect to a high portioning accuracy. An advantageous embodiment of the invention further consists in providing each filling station with at least one means for determining the amount of sausage meat needed by the respective filling station. The amount of sausage meat needed throughout the filling process can be determined by determining the amount of sausage meat needed by the individual filling stations, and the production process can be adapted accordingly.

A particularly advantageous embodiment of the invention consists in transporting sausage meat produced by the sausage-meat producing station under exclusion of air and under pressure at least in part from the sausage-meat producing station into the filling stations. Hygienic problems may arise from the contact of sausage meat with air, and a discoloration of the sausage meat is frequently observed in addition. This decrease in the product quality of the sausage meat can be avoided by preventing any direct contact of the sausage meat with air from the very beginning. In transporting the sausage meat under pressure from the sausage-meat producing station into the filling station, it is possible to ensure a constant sausage meat pressure at the inlet of the sausage-meat filling station. This is of particular advantage to the portioning accuracy of the filling station.

The method of the invention for producing and filling the prepared sausage meat consists in ejecting sausage meat from the production process—on the basis of the amount of sausage meat needed in the filling process—at least at a rate which lies between the rate of a deactivated production process and a full-load production process. It is possible by varying the rate at which sausage meat is ejected from the production process to ensure a continuous operation of the production process. A continuous production of sausage meat largely prevents oxidation of the sausage meat or sausage meat emulsion, which is observed when the sausage meat is allowed to stand for a long period of time.

Of particular advantage is here a method in which, depending on the amount of sausage meat respectively needed in the filling process of the sausage-meat producing process, sausage meat is ejected at a substantially continuously adjustable rate. Since it is possible to set the rate of ejection of the sausage meat in the production process in a substantially continuous way, a fine adjustment can be achieved between the long-term throughput of the sausage-meat filling station and the operative rate of the production process. A continuous operation of the production process at a constant production rate guarantees a high product quality together with a high product homogeneity.

Of particular advantage is here a method in which the sausage meat output of the production process is controlled on the basis of the amount of sausage meat needed in the filling process. A control of the sausage meat output of the production process on the basis of the amount of sausage meat needed in the filling process permits a substantial automation and synchronization of the sausage-meat producing process with the sausage-meat filling process.

A further advantageous development of the method according to the invention consists in temporarily storing the sausage meat after production and prior to filling. With a temporary storage, the sausage-meat producing process and the sausagemeat filling process are decoupled from one another at least in part, so that sausage meat throughput rates that vary for a short period of time can be compensated by way of storage.

A further advantageous embodiment of the method according to the invention consists in determining the amount of sausage meat needed by making a measurement as to how much sausage meat has been stored. Thanks to this method it is possible in an advantageous way to determine with relatively simple efforts the amount of sausage meat needed by a filling station and to adapt the ejection rate of the production process accordingly. A further advantageous development of the method consists in sensing the sausage meat throughput of the sausage-meat filling station for determining the amount of sausage meat needed. Since today's sausage-meat filling stations can be filled with sausage meat with a very high portioning accuracy, it is possible to determine the sausage meat throughput and thus the amount of sausage meat taken per time unit, for instance from a reservoir. On the basis thereof, it is possible to determine the amount of sausage meat needed by a sausage-meat filling station.

A particularly advantageous embodiment of the method according to the invention consists in running the production process and the filling process such that only a minimally necessary amount of sausage meat is stored. The expression “minimally necessary amount” refers to a quantity at which a continuous operation of the sausage-meat producing process is possible and means that the reservoir which stores the sausage meat always contains such an amount that a perfect function of the sausage-meat filling process is guaranteed. For instance, if there is not enough sausage meat available in the sausage-meat filling process, the sausage-meat filling process must be interrupted, which has a negative effect on the portioning accuracy. As a minimally necessary amount is stored, the dwell times of the sausage meat in the reservoir are reduced and thus the whole processing time of the sausage meat from its production process to its filling process. As has already been stated above, a long dwell time of the sausage meat has a negative effect on the product quality.

An embodiment of the method according to the invention shall now be explained with reference to the embodiment of the apparatus according to the invention with the help of the attached figures, of which:

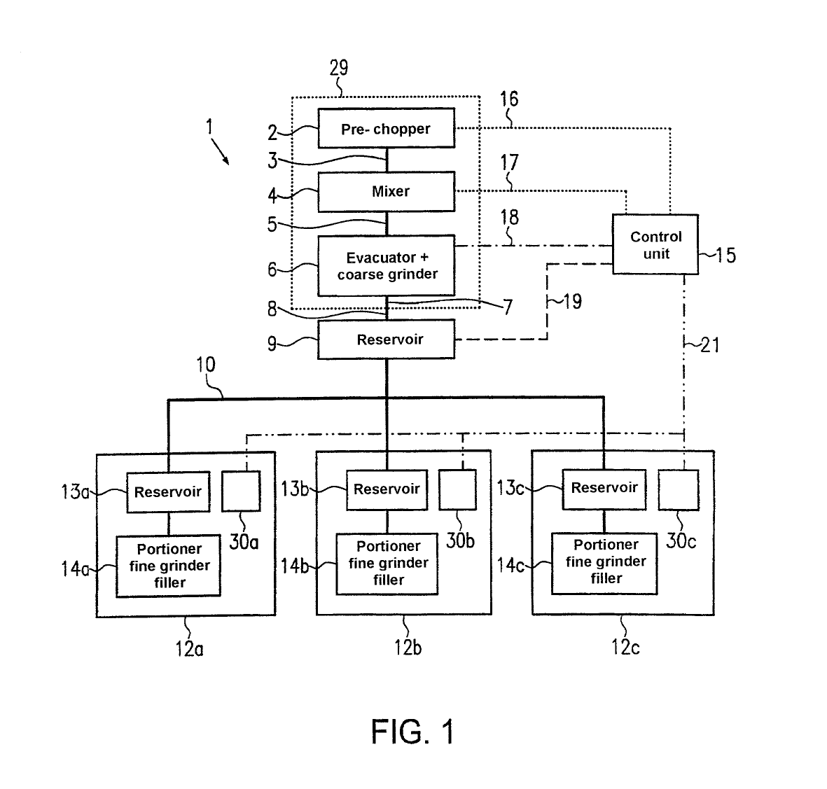

FIG. 1 shows a block diagram of a sausage-meat producing and filling apparatus according to a first embodiment which is in particular used for uncooked sausage made from sausage meat; and

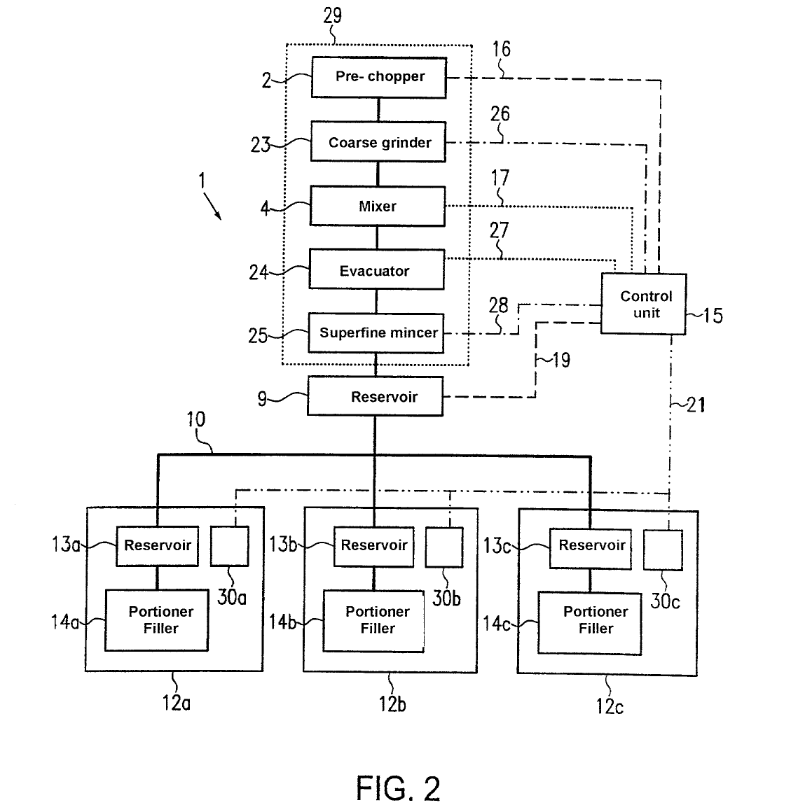

FIG. 2 shows a block diagram for an apparatus for producing and filling sausage meat according to a second embodiment which can in particular be used for sausage to be boiled.

As shown in FIG. 1, the apparatus 1 comprises a pre-chopper 2 which supplies prechopped material via a means 3 to a mixer 4 which supplies the mixed material via a means 5 to an evacuation-pump and coarse-grinder means 6. Reference numeral 29 designates the sausage-meat producing station. The sausage meat produced in this way is fed via an outlet opening 7 through a pipe 8 into an optional reservoir 9. In the absence of reservoir 9, the dwell time of the sausage meat prior to filling is further reduced, which has a positive effect on the quality of the sausage meat. The sausage meat is further fed from the reservoir 9 under exclusion of air through the pipes 10 to the portioning and filling units 12a, 12b, 12c. Each portioning and filling unit comprises a reservoir 13a, 13b and 13c. Furthermore, the filling units comprise a portioner, a fine grinder which grinds the sausage meat to its final graining, as well as a filler; these are summarized under reference numeral 14a, 14b and 14c. Means 30 determine the amount of sausage meat needed by the filling station, e.g. by measuring the contents of the reservoir 13. Alternatively, the amount of sausage meat needed can also be determined on the basis of the sausage amount throughput of the filling station. The sausage amount demand as determined is transmitted via the signal lines 21 to the control unit 15. Furthermore, the level of the reservoir 9 is transmitted via the signal line 19 to the control unit 15. In accordance with the amount of sausage meat needed, which follows here e.g. from the contents of the reservoir 9 and the reservoirs 13a, 13b and 13c, the pre-chopper 2, the mixer 4, as well as the evacuator, the pump and the coarse grinder 6 are controlled. In the absence of reservoir 9, the amount of sausage meat needed becomes only apparent from the reservoir contents of the respective filling stations or their sausage meat throughput, respectively.

FIG. 2 shows an apparatus which is particularly suited for producing and filling sausage meat for sausages to be boiled. In the pre-chopper 2 the material is pre-chopped and then coarsely ground in the coarse grinder 23. A mixer 4 which, for instance, also contains a pump supplies the mixed material to the evacuator 24 which supplies the material by means of a pump to the emulsifier 25, also called superfine mincer. The sausage meat exiting at the emulsifier is first stored in an optional reservoir 9. The sausage meat is introduced through the conduit system 10 into the filling stations 12a, 12b and 12c and is there stored in a reservoir 13a, 13b or 13c. The subsequent portioner and filler is combined under reference numeral 14. The filling units 12a, 12b and 12c comprise a means 30 which determines the amount of sausage meat needed, for instance by measuring the contents of the reservoir 13, and transmits the amount needed via line 21 to the control unit 15. The amount of sausage meat needed can also be determined via the sausage meat throughput of the filling unit. Furthermore, the reservoir 9 transmits the actual level via the signal line 19 to the control unit 15. In accordance with the amount of sausage meat needed, the control unit 15 controls the pre-chopper 2, coarse grinder 23, mixer 4 with pump, evacuator 24 with pump and emulsifier 25 via the signal lines 16, 26, 17, 27 and 28. Reference numeral 29 designates the sausage meat producing station.

The method according to the invention is carried out with the embodiment of the inventive apparatus of FIGS. 1 and 2 in the following way.

Depending on whether a sausage-meat producing station for sausages to be boiled or a sausage-meat producing station for uncooked sausage is concerned, sausage meat is produced in the sausage-meat producing station 29 with corresponding steps. The sausage meat produced in this way can first be temporarily stored in an optional reservoir 9. Subsequently, the sausage meat is passed on through the conduits 10 to the individual filling stations 12a to 12c and distributed there. The filling stations 12a, 12b and 12c store, portion and then fill the sausage meat produced. For instance, if reservoir 13c is very full, such a state is communicated to the control unit 15 via signal line 21. If at a specific time all of reservoirs 13a, 13b and 13c are already in a very full state, it is possible to fill reservoir 9 without any interruption in the production process. This optional reservoir 9 is capable of accommodating the whole amount or part of the sausage meat produced—at least temporarily. If, in addition to reservoirs 13, reservoir 9 also gets filled up, the control unit 15 will prompt the appropriate components of the respective sausage-meat producing station 29 to achieve a smaller sausage meat throughput which is different from zero. Thereupon, reservoir 9 and reservoirs 13, respectively, of the filling station 12 should gradually reduce their contents of sausage meat. The control unit 15 is able to set the sausage amount output of the sausage-amount producing station to a long-term mean of the amount of sausage meat needed by the filling stations. Capacities of the fillings stations that for short periods of time are either too high or too low can be compensated by means of reservoirs 9 and 13.

The reservoirs 9, 13 may be designed as pressure piston type reservoirs or as hopper-shaped vessels.

The individual filling stations can be separated from the whole system, for instance for cleaning purposes.

1. An apparatus for producing and filling sausage meat, comprising:
a producing station (29) for producing sausage meat,
a filling station (12a, 12b, 12c) for filling the sausage meat produced by said producing station, characterized by
a means (30a, 30b, 30c) for determining the amount of sausage meat needed by said filling station (12a, 12b, 12c), and
a control means (15) which controls the sausage meat output of said sausage-meat producing station (29) on the basis of the determined amount of needed sausage meat between the deactivation stage and the full load stage in at least one further intermediate stage in which the sausage meat output rate of said producing station (29) lies between the rates of a deactivated producing station and a full-load driven producing station.

2. The apparatus according to claim 1, wherein said control means (15) is designed such that the sausage meat output of said sausage-meat producing station (29) is controlled substantially continuously on the basis of the amount of sausage meat needed by said filling station (12a, 12b, 12c).

3. The apparatus according to claim 1 or 2, wherein at least one reservoir (9) for storing sausage meat is provided between said sausage-meat producing station (29) and said filling station (12a, 12b, 12c).

4. The apparatus according to any one of claims 1 to 3, wherein a means (3035a, 30b, 30c) for determining the amount of sausage meat needed is provided such that the sausage meat throughput of said sausage-meat filling station (12a, 12b, 12c) is sensed for determining the amount of sausage meat needed.

5. The apparatus according to any one of claims 1 to 4, wherein at least one pipe (10) for transporting sausage meat is provided between said sausagemeat producing station (29) and said filling station (12a, 12b, 12c).

6. The apparatus according to any one of claims 1 to 5, wherein said sausagemeat producing station (29) comprises a grinder (23) whose throughput is controlled by said control means (15).

7. The apparatus according to any one of claims 1 to 6, wherein said sausagemeat producing station comprises at least one mixer (4) whose sausage meat throughput is controlled by said control means (15).

8. The apparatus according to any one of claims 1 to 7, wherein said sausagemeat producing station (29) comprises at least one evacuator (6, 24) whose sausage meat throughput is controlled by said control means (15).

9. The apparatus according to any one of claims 1 to 8, wherein said sausagemeat producing station (29) comprises at least one pump (4, 6, 24) whose sausage meat throughput is controlled by said control means (15).

10. The apparatus according to any one of claims 1 to 9, wherein said sausagemeat producing station (29) comprises an emulsifier (25) whose sausage meat throughput is controlled by said control means (15).

11. The apparatus according to any one of claims 1 to 10, wherein said sausagemeat producing station (29) comprises a pre-chopper (2) whose throughput is controlled by said control means (15).

12. The apparatus according to any one of claims 1 to 11, wherein a plurality of filling stations (12a, 12b, 12c) are provided.

13. The apparatus according to claim 12, wherein at least one reservoir (13a, 13b, 13c) is provided for each filling station (12a, 12b, 12c).

14. The apparatus according to any one of claims 12 or 13, wherein for each filling station (12a, 12b, 12c) at least one means (30a, 30b, 30c) is provided for determining the amount of sausage meat needed by the respective filling station (12a, 12b, 12c).

15. The apparatus according to any one of claims 1 to 14, wherein the sausage meat produced is transported under exclusion of air and under pressure at least in part from said sausage-meat producing station (29) into said filling station (12a, 12b, 12c).

16. A method for producing and filling the sausage meat produced, characterized in that, on the basis of the amount of sausage meat needed by the filling process, sausage meat is ejected in the producing process at least at a rate which lies between the rate of a deactivated producing process and a full-load producing process.

17. The method according to claim 16, wherein, in response to the amount of sausage meat needed in the filling process of the sausage-meat producing process, sausage meat is ejected at a rate which is adjustable substantially continuously.

18. The method according to any one of claim 16 or 17, wherein the sausage meat output of the producing process is controlled on the basis of the amount of sausage meat needed in the filling process.

19. The method according to any one of claims 16 to 18, wherein the sausage meat is stored after production and prior to filling.

20. The method according to claim 19, wherein for the determination of the amount of sausage meat needed a measurement is carried out as to how much sausage meat is stored.

21. The method according to any one of claims 16 to 20, wherein for the determination of the amount of sausage meat needed, the sausage meat throughput of the sausage-meat filling station is sensed.

22. The method according to any one of claims 16 to 21, wherein the sausage-meat producing process is carried out such that a minimally necessary amount of sausage meat is stored.
